(19) United States
(12) Patent Application Publication
(10) Pub. No.: US 2008/0286194 A1
(43) Pub. Date: Nov. 20, 2008

(54) Metal-Vanadium-Oxide Product and Producing Process

(76) Inventors: Tom Eriksson, Sandviken (SE); Sara Nordlinder, Sandviken (SE)

Correspondence Address: SCHIFF HARDIN, LLP;PATENT DEPARTMENT, 6600 SEARS TOWER, CHICAGO, IL, 60606-6473, US

(21) Appl. No.: 11/885,370

(22) PCT Filed: Mar. 2, 2005
(86) PCT No.: PCT/SE2005/000312

§ 371 Date: Apr. 21, 2008

(51) Int. Cl. C01G 31/02

(52) U.S. Cl. 423/594.8

(57) ABSTRACT

Metal-vanadium-oxide-product where the metal is Au, Ag or Pt and where the product is obtained by ion exchange of nanotubular vanadium oxide comprising vanadium oxide layers separated by templating molecules with a solution of a salt of the metal. Use of the metal-vanadium-oxide-product according to the invention as active cathode material in a battery. A process of producing of the metal-vanadium-oxide-product according to the invention. An active cathode material comprising a metal-vanadium-oxide-product according to the invention. A lithium battery comprising at least one lithium anode, at least one vanadium oxide cathode, an electrolyte and an adhesive layer bonding each of the anodes and the cathodes to the electrolyte, where the vanadium oxide cathode comprises a metal-vanadium-oxide-product according to the invention.

### TECHNICAL FIELD OF THE INVENTION

The invention concerns a new nanosized product. The product may be used as active cathode material in a cell, such as a primary lithium cell or battery, especially a cell to be used in an implanted cardiac defibrillator.

### BACKGROUND OF THE INVENTION

Lithium based batteries have become commercially successful due to their relatively high energy density. Suitable positive electrode materials for lithium based batteries include materials that can intercalate lithium ions into their lattice. Vanadium oxides in certain oxidation states are effective materials for the production of positive electrodes for lithium based batteries. Also, metal vanadium oxide compositions have been identified as having high energy densities and high power densities, when used in positive electrodes for lithium based batteries. Silver vanadium oxide has a particularly high power density and a reasonably high energy density. Silver vanadium oxide batteries have found particular use in the production of implantable cardiac defibrillators where the battery must be able to recharge a capacitor to deliver large pulses of energy in rapid succession, typically within ten seconds or less.

To be able to produce small scale batteries and to obtain a high surface area it is preferred to use small size particles in the electrodes. Therefore, use has been made of nanosized vanadium oxide particles and metal vanadium oxide particles. This is described in U.S. Pat. No. 6,225,007. The vanadium oxide nanoparticles are produced by laser pyrolysis. The metal vanadium oxide particles are formed from these nanoparticles and a compound of the non vanadium metal by a thermal process using temperatures up to 500° C. This is an expensive and time and apparatus consuming process.

Attempts have been made to use vanadium oxide nanotubes instead of the vanadium oxide nanoparticles. No laser pyrolysis is required to produce the nanotubes.

The vanadium oxide nanotubes consist of several vanadium oxide layers, commonly in a scroll-like arrangement, separated by structure-directing agents (templates). The tubes can be up to 15 μm long and consist of as many as 30 vanadium oxide layers. The outer and inner diameters vary between 15 to 100 nm and 5 to 50 nm, respectively. The size depends on the precursors chosen for the synthesis and can therefore be controlled in a rough manner.

According to Niederberger, M.; Muhr, H. -J.; Krumeich, F.; Bieri, F.; Günther, D.; Nesper, R., Chem. Mater. 2000, 12, 1995 vanadium oxide nanotubes can be produced by a sol-gel reaction, followed by hydrothermal treatment, from vanadium(V) alkoxide and primary monoamines. Niederberger also reports the use of vanadium(V) oxytrichloride or vanadium(V) pentoxide as vanadium source. As templating amines e.g. undecyl-, dodecyl- and hexadecylamine can be used.

According to U.S. Pat. No. 6,210,800 (by Nesper et. al.) vanadium-triisopropoxide is added to hexadecylamine under argon atmosphere and the mixture is then stirred for one hour. The created solution is later hydrolyzed and an orange precipitation formed, which is aged during agitation for one day. This reaction mixture is heated in an autoclave at stepwise increasing temperatures. The reaction product is separated, washed and dried.

A synthesis of vanadium oxide nanotubes (VOx-NTs) is also described by Spahr et al. [Angew. Chem. Int. Ed. Engl., 37,1263 (1998)]. The synthesis is performed with e.g. primary alkylamines as templating molecules. Suitable templating molecules are hexadecylamine (C16) and dodecylamine (C12). The embedded amine molecules can readily be exchanged by various metal cations, e.g. alkaline and alkaline earth metals, under preservation of the tubular morphology. However, if the embedded ions are removed the material collapses.

Substitution by Na-ions can be performed with e.g. C12—VOₓ nanotubes which have proved to be the best starting material for exchange reactions. The Na⁺-exchange is performed using NaCl salt. Specifically, the exchange reactions are performed by stirring a suspension of nanotubes in ethanol with an excess of the exchanging NaCl, followed by drying under vacuum. According to U.S. Pat. No. 6,653,022 the product obtained may be used as electrode material in a rechargeable lithium battery.

Thus, it is known to use silver vanadium oxide, SVO, as active cathode material. It is also known to use nanotubular vanadium oxide with embedded alkaline metal ions as active cathode material.

The metal ions in SVO participate in the electrochemical reactions of the cell by being reduced to metallic state. With the silver in the metallic state the electrical conductivity of the cathode is improved. The electrical conductivity of the elemental metal is thus an important property to optimize the cathode material. It would therefore be an advantage to be able to insert ions of e.g. the coin metals Ag, Au and Cu into a nanotubular structure. The electrical conductivities of these metals are 63, 45 and 57.9 MS/m, respectively. The electrical conductivity of sodium is only 19 MS/m.

It was found that when VOₓ-nanotubes are treated with a solution of a salt of one of the metals Au, Ag or Pt the remote order of the nanotube lattice is changed and the metals are precipitated. It was surprisingly found that the obtained products perform better than nanotubes obtained by ion exchange with solutions of salts of other metals, where the products contain ions of the metal used and where the nanotubes retain their original structure.

### SUMMARY OF THE INVENTION

Thus, the invention concerns a metal-vanadium-oxide-product where the metal is Au, Ag or Pt, preferably Ag, and where the product is obtained by ion exchange of nanotubular vanadium oxide comprising vanadium oxide layers separated by template molecules with a solution of a salt of the metal.

The invention also concerns a metal-vanadium-oxide-product where the metal is Au, Ag or Pt, comprising vanadium oxide nanotubes having defects and containing nanometersized particles of the metal in elemental form, preferably having a particle size of 10-600 nm, especially where a majority of the particles have a size around 100 nm, and where the product is obtained by ion exchange of nanotubular vanadium oxide comprising vanadium oxide layers separated by templating molecules with a solution of a salt of the metal. Preferably an aqueous solution is used at the ion exchange.

The invention further concerns the use of the metal-vanadium-oxide-product of the invention as an active cathode material in a battery and an active cathode material comprising the metal-vanadium-oxide-product. Further the invention concerns a lithium battery having a cathode containing such a product and method of producing the metal-vanadium-oxide-product.

When the product is to be used as an electrode in a battery this electrode may be prepared by admixing a particulate form of the present vanadium oxide nanotubes product with a fine-grain carbonaceous material and a polymeric binder material; stirring, shaking or milling the particulate admixture; spreading the particulate admixture onto a surface; extracting electrodes from the spread particulate admixture; and drying the extracted electrodes.

When the product is to be used as an electrode in a battery this electrode may for instance be prepared as described in U.S. Pat. No. 6,663,022 by admixing a particulate form of the present vanadium oxide nanotubes product with carbon black and EPDM binder; stirring the particulate admixture of vanadium oxide nanotubes product, carbon black and EPDM binder; spreading the stirred particulate admixture onto a surface; extracting electrodes from the spread particulate admixture; and drying the extracted electrodes.

The invention also concerns a process of producing a metal-vanadium-oxide-product according to the invention where vanadium oxide nanotubes are produced from a solution of vanadium pentoxide and an alkylamine and the obtained nanorolls are mixed with an aqueous solution of a salt of the metal, the mixture is stirred and thereafter washed and dried.

The metal salt used for ion exchange may be for instance AuCl₃, Au(CN)₃, AgNO₃, AgC₂H₃O₂, AgClO₃, AgF, PtCl₄, PtI₄ or H₂PtCl₆. Preferably AuCl₃, AgNO₃, or PtCl₄ is used.

### BRIEF DESCRIPTION OF THE DRAWINGS

FIG. 1 shows a micrograph of VOₓ nanotubes obtained by a transmission electron microscope (TEM).

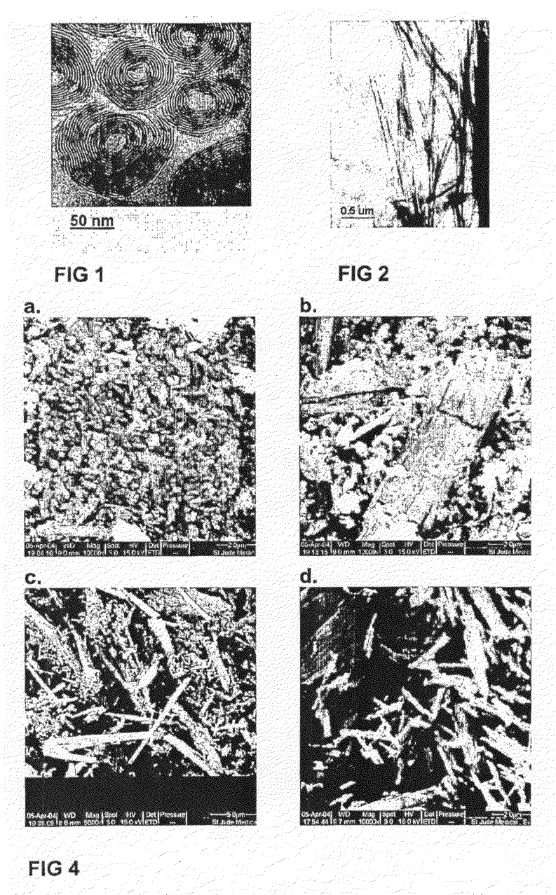

FIG. 2 shows a TEM micrograph of VOₓ nanotubes containing Na⁺ ions.

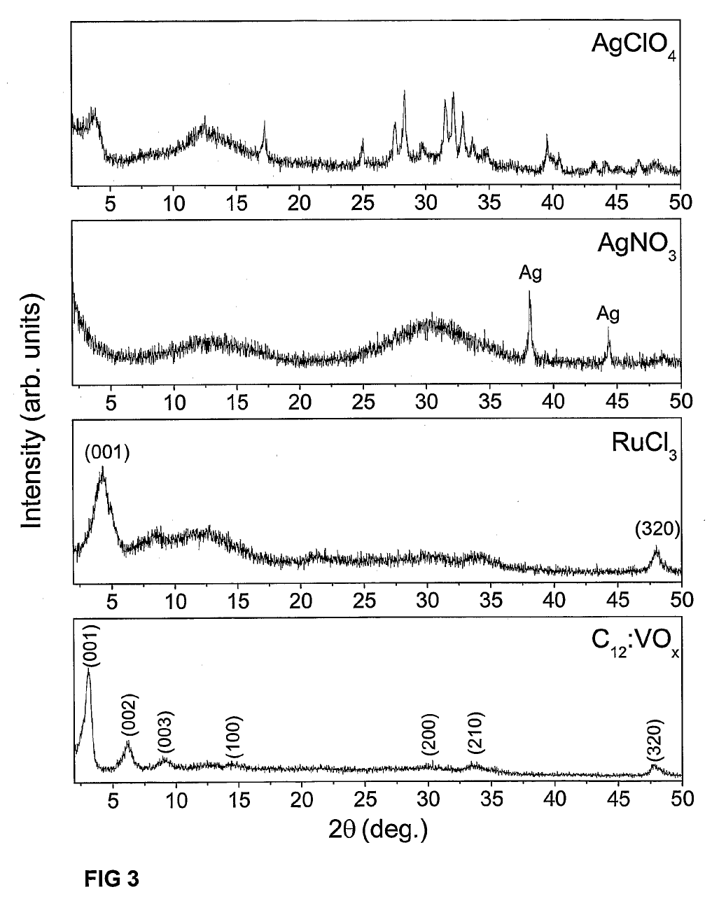

FIG. 3 shows X-ray diffractograms of the as-synthesized VOₓ-nanotubes (C_{I2}:VOₓ₅ bottom figure) and ion-exchanged nanotubes.

FIG. 4 shows SEM pictures of a) AgNO₃ ion-exchanged material. b) AgNO₃ ion-exchanged material. c) AgClO₄ ion-exchanged material. d) Original NT-VOₓ material.

FIG. 5 shows TEM pictures and SAED patterns for the AgNO₃ ion-exchanged sample.

FIG. 6 show two diagrams: a) The first discharge-charge cycle for an Ag—VOₓ electrode and b) the discharge capacity for the same electrode.

FIG. 7 shows two diagrams: a) a pulse-test of the Ag—VOₓ material and b) the rate capability of the Ag—VOₓ material.

### DETAILED DESCRIPTION OF THE INVENTION

The invention concerns a nanotubular product obtained by ion exchange of VOₓ-nanotubes with a solution of a metal salt where the metal is Au, Ag or Pt. It was surprisingly found that the product obtained with the use of these metals differs essentially from the product obtained when the ion exchange is performed with e.g. Na.

When performing the ion exchange with Au, Ag or Pt ions the structure of the nanotubular product changes. Defects are introduced and the remote order of the lattice is changed. Also, the metal ions are reduced and metal is precipitated. This type of reaction is especially prominent when the ion exchange is performed with a solution containing monovalent ions of Ag and Au and with divalent Pt-ions. In this respect it is to be noted that the metal ions may be reduced or oxidized during the ion-exchange. Therefore, an ion-exchange solution containing from the start Au³⁺ may during the ion-exchange process change to contain also Au⁺.

A possible explanation to this phenomenon is the different behaviour between large, “soft” metal ions such as Ag⁺, Au⁺ and Pt²⁺ and small, “hard” metal ions such as Na⁺, K⁺, Ca²⁺, Mn²⁺, Fe³⁺ and Al³⁺. Pt⁴⁺ is also a soft ion while Au³⁺ has intermediate properties and could be termed semi-soft.

The possibility of a metal ion to form coordination compounds is related to its ability to function as Lewis acid and the ability of the ligand to function as a Lewis base. The “hard” metal ions are difficult to polarise while the “soft” metal ions are easy to polarise. The different types of metal ions bind preferentially to different types of ligands. The “hard” metal ions bind preferentially to oxygen while the “soft” metal ions preferentially bind to e.g. the heavier halides and to CO.

It is possible that for the nanotubular structure to remain intact after ion exchange it is necessary that the metal ions easily bind to oxygen sites in the nanotubes. In that case the exchange using ions of Ag, Au and Pt may not work as well as the exchange using the “hard” metal ions. Instead of an ordinary ion exchange, the ions precipitate as metal and there is a reaction/collapse of the tubes.

The following examples show precipitation of silver and extensive changes in the nanotubular structure of VOₓ after ion exchange with silver nitrate. Such behaviour is not shown in earlier performed ion exchange with for example alkaline and alkaline earth metal ions. It is also contrary to what is shown in Azambre, B.; Hudson, M. J. “Growth of copper nanoparticles within VOₓ nanotubes” Materials Letters 57 (2003), 3005-3009 and Azambre, B.; Hudson, M. J., Heintz, O. “Topotactic redox reactions of copper(II) and iron(III) salts within VOₓ nanotubes” J. Mater. Chem. 2003, 13, 385-393. In those articles two studies of ion exchange of VOₓ nanotubes with CuCl₂·2H₂O dissolved in an aqueous solvent containing 90% (vol/vol) ethanol are discussed. In one of the studies ion exchange with FeCl₃·4H₂O in the same solvent is also performed. It is disclosed that Cu²⁺ in this case induces a rearrangement in the basal plane of the vanadium oxide and that SEM examination revealed existence of tubular structures.

Some tubes were found to be partly damaged. However, the multiwalled structures were relatively better preserved for the Cu²⁺-substituted sample than for the Fe³⁺-substituted material. Although XPS showed that the copper species were mainly present in reduced oxidation states (+1 or 0) the TEM micrographs did not reveal any Cu-particles. Only by controlled thermolyses in nitrogen up to 650° C. of the Cu²⁺ dispersed within the multiwalls was growth and sintering of copper nanoparticles visible in HRTEM micrographs achieved. These particles had a particle size of 5-70 nm. The tubular structure was largely retained although changed to single-walled V₂O₃ nanotubes.

It is therefore surprising that a simple ion exchange with ions of Ag, Au and Pt, without any treatment at high temperature, will produce a product comprising nanosized particles of the metal and an extensively changed nanotubular structure. It is further surprising that this product has superior electrochemical properties.

In the following examples the invention is further illustrated.

### EXAMPLES

With the object of providing a new active cathode material to be used in a lithium battery the possibility of synthesizing vanadium oxide (VOₓ) nanotubes with embedded Ag⁺ ions was investigated. If the synthesis was successful the product would undergo further electrochemical testing to asses its prospects as an electrode material for lithium battery systems.

Most silver salts are very difficult to dissolve in the aqueous solutions used in the synthesis. Two different silver salts: AgNO₃ and AgClO₄, both soluble in water, were tested.

The VOₓ nanotubes were prepared as described by Niederberger et al., Chem. Mater. 2000, 12, 1995. V₂O₅, (Aldrich), was used as a precursor and dodecylamine, C₁₂H₂₅NH₂ (99% Aldrich), as a structure-directing molecule. Vanadium pentoxide and dodecylamine, in the molar ratio 2:1, were dissolved in ethanol and stirred under argon atmosphere for 2 h. The yellow liquid was hydrolyzed and the resulting dark orange gel was left to age for 24 h (while stirring on a magnetic stirrer). After aging, the gel was transferred to a stainless steel autoclave and heated at 180° C. for 7 days. The synthesis resulted in a black powder, consisting of VOₓ nanorolls, which was washed in ethanol and dried under vacuum at 80° C. for more than 12 h. The powder consists largely of spherical conglomerates of nanotubes.

The ion exchange was performed as described by Reinoso et al., Helv. Chim. Acta 2000, 83, 1724, but using the salts AgNO₃ (May & Baker Ltd.) or AgClO₄ (Aldrich). The nanotubes were mixed with the silver salts in the molar ratio 1:4 (VOₓ:salt). The salts were first dissolved in the solvent before adding the VOₓ-powder. For the AgNO₃ salt, 70 ml of an ethanol:H₂O solution (4:1 by volume) was used as solvent. 1.00 g VOₓ was added to 1.30 g AgNO₃. The AgClO₄ salt (1.12 g) was dissolved in 50 ml de-ionized H₂O after which 0.70 g VOₓ powder was added. The mixes were stirred on a magnetic stirrer for 4 h, after which they were washed and dried as above.

When the embedded ions of the structure-directing agents are exchanged for Ag in AgNO₃, metallic Ag is obtained in the resulting product instead of Ag-ions. At the same time defects are introduced into the tubular structure of the vanadium oxide. The remote order of the lattice is changed. This new product is surprisingly more effective as electrically active material in a cathode in a lithium battery in spite of the fact that Ag⁺ already has been reduced to Ag-metal.

Thus, the new product differs from known nanotubular vanadium oxide not only by the metals introduced but also by a different morphology.

When the embedded ions of the structure-directing agents are exchanged for Ag in AgClO₄ the nanotubes are destroyed by oxidation and AgVO₃ is obtained. This product was not tested as electrically active cathode material.

Surprisingly the new product seems to have a higher capacity than the presently used SVO, in spite of the fact that silver is already reduced to metallic state, as well as previously investigated VOₓ materials. A possible explanation is that the defects introduced into the tubular structure facilitate the intercalation of lithium into the structure. It would also seem that the vanadium of the vanadium oxide is at a higher oxidation state than in the original vanadium oxide nanotubes.

### Characterization

Powder X-ray diffraction (XRD) was performed on a SIEMENS D5000 diffractometer (CuK_{α} radiation, λ=1.5418 Å) between 2° and 50° in 2θ. The powders were evenly distributed on a zero background Si-plate.

Raman spectra were collected using a Reinshaw 2000 spectrometer equipped with a 785 nm diode laser.

Scanning electron microscopy (SEM) was performed on an FEI Quanta 200, equipped with Link Inca energy dispersive spectroscopy (EDS) system.

Transmission electron microscopy (TEM) measurements were made with a JEOL 2000 FXII with a 200 kV working voltage.

### Electrochemical Testing

Electrodes were prepared by extrusion of a slurry containing 80 wt % VOₓ nanotubes, 10 wt % Acetylene Black (Chevron) and 10 wt % ethylene propylene diene terpolymer (EPDM) binder onto an aluminum foil. Circular electrodes (20 mm in diameter) were dried under vacuum over night inside an argon-filled glove box (O₂/H₂O<2 ppm) prior to use. The mass loading on the electrodes was around 2 mg/cm².

Two- or three-electrode cells were assembled inside the glove box, using VOₓ nanotubes as working electrode, a glass fibre cloth soaked in electrolyte as separator and lithium-metal as counter and reference electrode. The electrolyte was 1 M lithium bis(trifluoromethylsulfonyl)imide, (LiTFSI, Rhodia) in ethylene carbonate (EC)/dimethyl carbonate (DMC) (both Selectipur®, Merk) 2:1 by volume. The solvents were used as-received, while the salt was dried under vacuum at 120° C. for 24 h in the glove box prior to use. The cell components were vacuum-sealed into polymer-coated aluminum pouches.

Galvanostatic cycling, using two-electrode cells, were performed between 3.5 V and 1.3 V (all potentials are given vs. Li/Li⁺, i.e. −3.04 V vs. a standard hydrogen electrode) using a Digatron MBT testing unit, with BTS-600 software. The first cycle was made with a current loading of 10 mA/g active material, and the subsequent cycles with 25 mA/g active material.

Pulse-experiments, using three-electrode cells, were performed between 3.5 V and 1.3 V using an Arbin BT2000 with MITSPro software. The background current used was 3 mA/g (10 μA). To simulate an implantable cardioverter defibrillator (ICD) capacitor charge the rate of an ICD shock was determined. The typical ICD battery size is 2 Ah, while the capacitor take 3 A from the battery during its charge. This gives 2/3 h for a complete discharge of a typical ICD battery with the heaviest load possible, and the rate is thus 1.5 C during this heavier load. This was translated in accordance to the mass load in the experimental cell design, and gave 375 mA/g (1.23 mA). Another test was set up to test the capacity at different discharge rates. This tested 5 cycles each at: 100 mA/g, 300 mA/g, 600 mA/g, 100 mA/g, and 30 mA/g. This responds to: C/2, 2C, 3C, C/2, C/6. All pulse and rate capability testing was made with the batteries in an oven at 37° C.

### Characterization

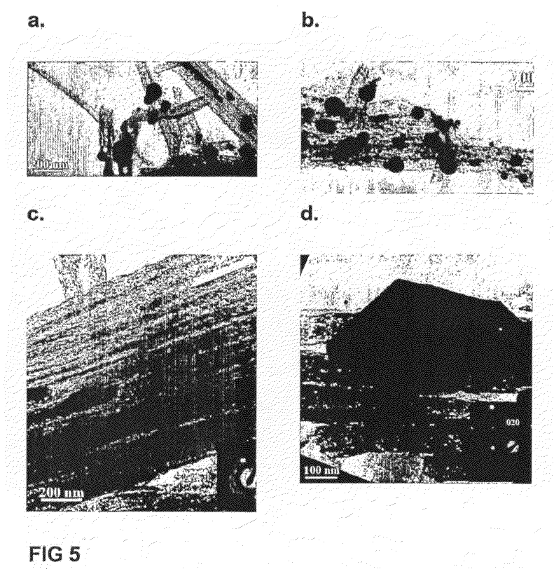

X-ray powder diffractograms of the two different ion-exchanged VOₓ-samples as well as the diffractogram for the starting material are presented in FIG. 3. The reflections at 2θ<15°, found in the diffractogram of the starting material, are 00l-peaks, typical for layered structures. Reflections at 2θ>15° originate from the structure within the vanadium oxide layers. After ion exchange, the 00l-peaks normally shifts to higher 2θ, reflecting a decrease in interlayer distance. A successful exchange should result in a 001-reflection at around 10° in 2θ as well as a preservation of most of the intra-layer reflections.

The diffractogram of the AgClO₄-product shows several new peaks. These can all be associated with AgVO₃. The vanadium oxide nanotubes have obviously been oxidized to form this new compound. ClO₄⁻ is a fairly strong oxidant, so this result is not surprising.

For the AgNO₃-sample, only two peaks can be seen both of which belong to elemental silver suggesting that the Ag⁺-ions have been reduced to Ag(s). There are no reflections from the original VOₓ structure.

Raman measurements show different regions in the material. A surface enhanced Raman spectroscopy (SERS) effect could be observed, also indicating the presence of metallic silver (this is when the SERC phenomenon occurs). No evidence of a reversible reaction to V₂O₅ could be seen. V₂O₅ have distinct bands in Raman and would have been easily detected.

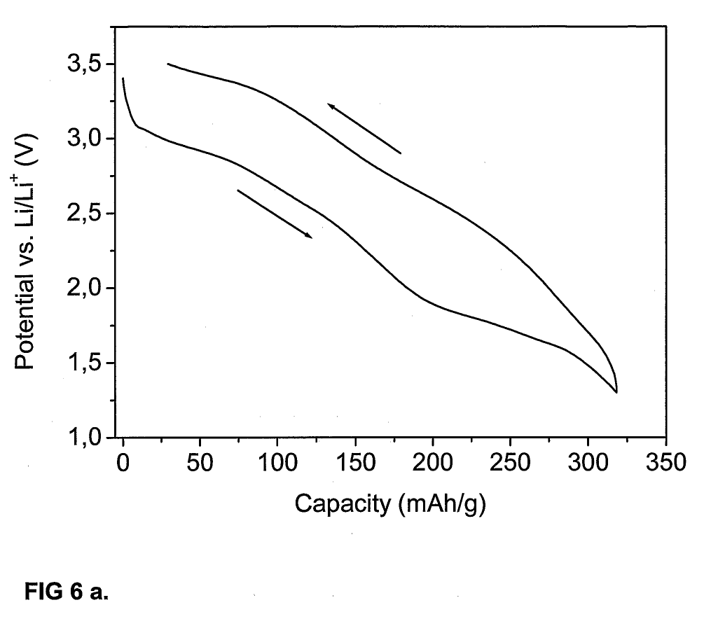

SEM showed a morphology with a mixture of smaller and larger particles, see comparison between FIGS. 4a and 4b. Some bundles of VOₓ nanotubes could be seen in the AgNO₃ ion-exchanged material, although most of that material consisted of sub-micron particles (FIG. 4a). The morphology for this material looks completely different from the original powder (FIG. 4d), with more small particles and a more homogeneous particle mix. EDS tells us that the silver is dispersed throughout the matrix of the materials in FIGS. 4a, 4b and 4c. The AgClO₄ ion-exchanged material consists of sharp needles, just like the original material and many types of vanadium oxide materials.

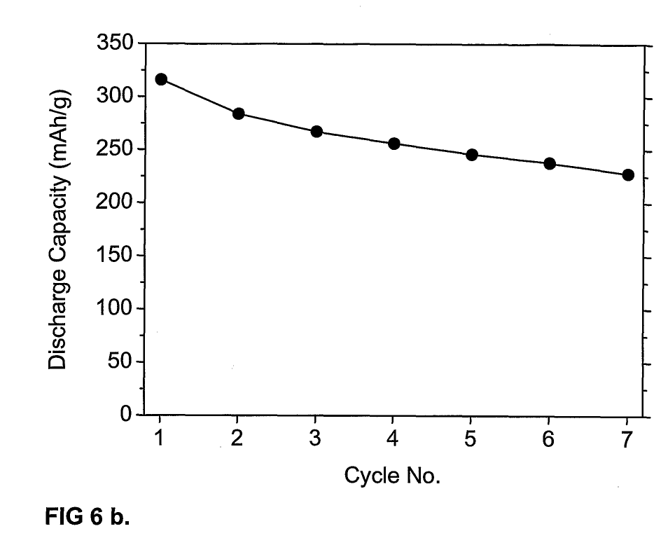

The TEM measurements show that the tubes as more or less distorted with some tubular morphology intact but with a large number of defects introduced in the structure (FIG. 5a-c). The silver is precipitated as grains that range from 10 to 600 nm, with the majority of the particles around 100 nm in size. FIG. 5d shows a large silver particle and the inlet gives the selected area electron diffraction (SAED) pattern for this particle. It clearly shows that the darker particles are cubic metallic silver grains. In FIG. 5c the inlet shows the SAED pattern from the bundle of tubes in this picture. The pattern is diffuse and it is hard to distinguish any structural information from this measurement. The long-range order for the VOₓ part of the sample seems to have decreased substantially, which is in agreement with the XRD measurement. It can also be seen that there are darker parts in FIG. 5c that could be assigned to silver in the tubular structure, but this is less common for the sample.

### Electrochemical Testing

Ag—VOₓ

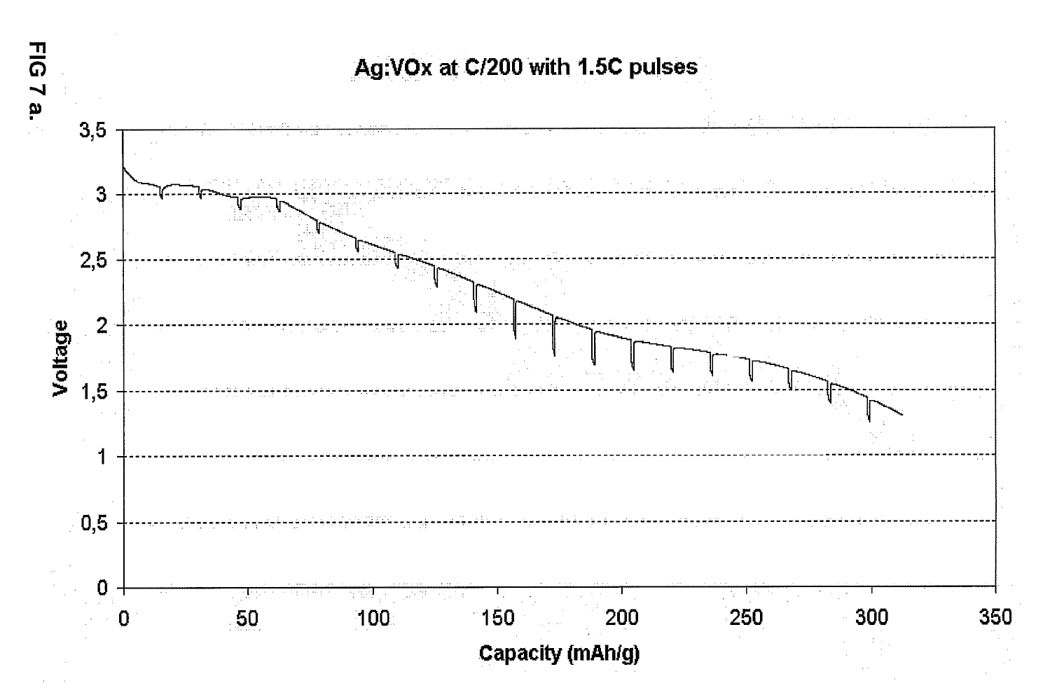

The potential profile for the first discharge-charge and the capacity for cycle 2-7 can be seen in FIGS. 6 a, b. Three plateaus, at approximately 3.0 V, 2.6 V and 1.6 V, can be seen in the potential curve. However, the plateaus are not distinct.

The practical capacity is larger than the theoretical capacity for the VOₓ-material which has been estimated to ˜240 mAh/g (Nordlinder, S.; Lindgren, J.; Gustafsson, T.; Edstüm, K. J. Electrochem. Soc. 2003, 150, E280). This indicates that the active VOₓ material could have vanadium in a higher oxidation state than the original VOₓ tubes with the embedded amine molecule, in order for the red-ox reaction to generate such a large capacity value.

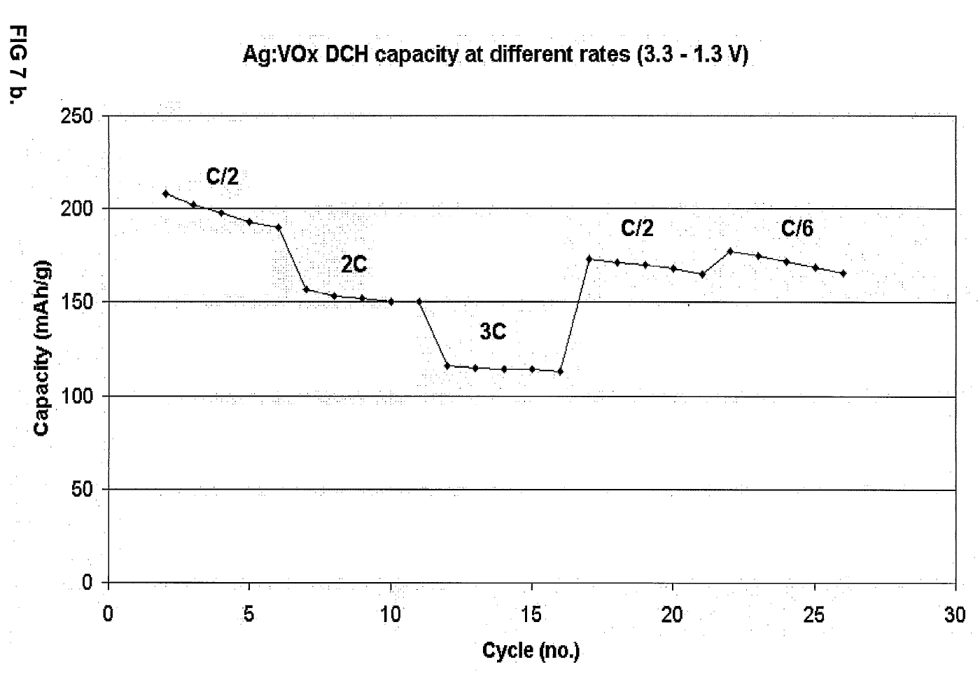

From the pulse-testing of the Ag—VOₓ material the over-potential, or voltage-delay, is very good at beginning of life, down to 2.3-2.4 V where the internal resistance starts to increase and the material has a slower response (FIG. 7 a). This levels out just below 2.0 V and then the response gets better again, i.e. there is a decrease in the over-potential. The cell hits the 2.0 V mark at about 150 mAh/g, and the 1.5 V mark around 275 mAh/g.

When using the cell as a rechargeable battery the capacity at different discharge rates was tested (FIG. 7 b). The test showed a good discharge capacity even at rates as high as 3 C (600 mA/g), rendering ˜115 mAh/g. The capacity fade upon cycling can be seen and after a series of high rate discharges the material is not quite capable of returning to the high capacity values as in the first number of cycles.

We claim as our invention:

1. Metal-vanadium-oxide-product where the metal is Au, Ag, Cu or Pt and where the product is obtained by ion exchange of nanotubular vanadium oxide comprising vanadium oxide layers separated by templating molecules with a solution of a salt of the metal.

2-25. (canceled)
